(19) United States
(12) Patent Application Publication
(10) Pub. No.: US 2007/0140077 A1
(43) Pub. Date: Jun. 21, 2007

(54) OPTICAL DISC RECORDING APPARATUS CAPABLE OF MARKING LABEL SIDE OF OPTICAL DISC

(75) Inventors: Yu-Ming Kang, Hsinchu (TW); Chi-Yuan Liu, Hsinchu (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Lite-On It Corp., Taipei City (TW)

(21) Appl. No.: 11/610,020

(22) Filed: Dec. 13, 2006

(30) Foreign Application Priority Data
Dec. 16, 2005 (TW) 094144834

(51) Int. Cl. G11B 7/00

(52) U.S. Cl. 369/44.29; 369/44.34

(57) ABSTRACT

After the learning step of an optical disc recording apparatus for writing a label side of an optical disc is accomplished, the focusing servo control signal includes an offset voltage component. Before or after the focusing servo control signal is converted into an analog output signal, the signal is processed by a low pass filter to remove a high-frequency portion so as to smoothen the signal, thereby removing the color or grey level gaps of the resulting pattern marked on the label side of the optical disc.

### FIELD OF THE INVENTION

The present invention relates to an optical disc recording apparatus capable of marking the label side of an optical disc, and more particularly to an optical disc recording apparatus capable of marking the label side of an optical disc with alleviated noise.

### BACKGROUND OF THE INVENTION

In the age of multimedia, high volume high quality video and audio data and even high quality game software have occupied a great part of the market. These data need to be stored in a fast-accessing, low cost and high capacity storage medium, and is preferably able to efficiently make spare copies. Various recordable/rewritable optical discs and corresponding recording apparatus having the feature of making a spare copy of large amount of data in an inexpensive way are thus developed. An optical disc is commonly used for storing large amount of video and audio data, software, or material and configuration data in professional applications. Therefore, not only has the optical disc recording apparatus become indispensable peripheral equipment for both personal computers and laptops in today's computer industry, in the mainstream digital consumer market, optical disc recording apparatus have begun playing an important role. Users who frequently use the optical disc recording apparatus to create a spare copy of data into a commercial recordable/rewritable optical disc that is pre-designed with monotonous and common label side might suffer from distinguishing these recorded discs.

Conventionally, permanent markers or special pens are used to mark the recorded disc, but human's handwritings are subject to inconvenience or misunderstanding. Printed labels stuck on the non-data face of the recorded disc are another option to specify the information of the disc. The requirements on weight distribution and adhesion of the labels are critical because the uneven weight distribution would adversely affect the rotation of the disc and the fallen-off label could jam the machine.

In light of these issues, a special dye layer that can be burned to form a desired configuration is provided on the label layer of the optical disc. In this way, the label side can be provided with desired marks such as patterns or letters. Marking the label side of an optical disc is generally performed after data is written into the data side of the optical disc. The disc is taken out of the optical disc recorder, flipped to the other side and placed back into the optical disc recorder, and the optical head of the optical disc recorder then projects laser light onto the label side of the optical disc where the special dye is applied to induce a chemical reaction, thereby changing the color of the dye layer and forming a desired pattern on the label side.

Please refer to FIG. 1(a) which schematically shows the label side of a recordable/rewritable optical disc. The optical disc 100 includes a plurality of regions, e.g. a concentric center hole 120 and an annular information area 110. In addition, there is an annular reference region 130 disposed between the center hole 120 and the information area 110 and adjacent to information area 110, as shown in FIG. 1(b). The annular reference region 130 is previously provided with a certain pattern and includes an outer ring 140 and an inner ring 160. The outer ring 140 that is not uniformly patterned is recorded with a media ID, a saw tooth and an index mark. The inner ring 160, on the other hand, is provided with a uniform pattern, i.e. alternate “dark” and “bright” spokes, for rotation control while marking the label side. Meanwhile, the saw tooth on the outer ring 140 is used for shift calibration of the optical head, and the media ID and index mark provide other information relating to the optical disc 100. In general, the information of the outer ring 140 is accessed by the optical head, while the information of the inner ring 160 is realized by a spoke detector.

FIG. 2(a) is a diagram schematically illustrating a part of an optical disc recording apparatus 10, wherein a turn table 50, a spindle motor 60, a spoke detector 70 and an optical head 80 are shown. FIG. 2(b) is a functional block diagram illustrating means for controlling the optical head 80 to read/write an optical disc in the optical disc recording apparatus 10, wherein a DSP (digital signal processor) 11, a DAC (digital-to-analog converter) 12, a driving circuit 13 and an actuator 14 for moving the optical head 80 are shown. When the specific optical disc 100 is placed on the turn table 50 that is rotated by the spindle motor 60, the information recorded in the outer ring 140 and the inner ring 160 of the reference region 130 can be realized by the optical head 80 and the spoke detector 70, respectively. The spoke detector 70 is mounted in the optical disc recording apparatus, and comprises a light source and a light receiver. The light source emits a light beam onto the inner ring 160 and the reflected light beam is received by the light receiver, thereby generating an inner ring signal or spoke signal. The optical head 80 is controlled by a stepping motor to move along the radial direction for reading the Media ID, Saw Tooth and Index Mark recorded in the outer ring 140, thereby generating an outer ring signal. Since these 400 spokes are equally spaced in the inner ring 160, the spoke signal generated by the light receiver is a square wave signal with substantially 50% duty cycle. When the light receiver generates one cycle of square wave, it is indicated that the optical disc has rotated 1/400 cycle, and the generation of 400 square waves represent one cycle of rotation of the optical disc.

The starting spoke for marking the optical disc 100 is located according to both the patterns in the outer ring 140 and the inner ring 160. The starting spoke can be any of the 400 spokes (Spoke No. 0˜399), and usually the optical disc recording apparatus defines Spoke No. 0 as the starting spoke. After the starting spoke is defined, all circumferential positions on the optical disc 100 can be defined by counting the number of the square waves generated by the spoke detector 70.

For marking the label side of the optical disc, the annular information area 110 is defined with a plurality of concentric tracks, and one track is marked at one time, starting with the inner track radially and the previously defined starting spoke circumferentially or angularly. By way of the coarse drive of the stepping motor, the fine tune of the optical head and the rotation of the optical disc, information can be recorded into designated positions in designated tracks.

The patterns or letters to be marked on the label side of the optical disc are provided by the host of the optical disc recording apparatus as a function of tracks and spokes.

In addition to the positioning technique mentioned above, focusing is another issue for marking the label side of the optical disc. Typically, the reflectivity of the label side is approximately 10%, which is much lower than the reflectivity of the data side (e.g. approximately 45%). Due to the low reflectivity of the label side, it is difficult for the lens of the optical head to focus the laser beam onto the label side of the optical disc in a closed-loop control manner. Accordingly, open-loop control is adapted and a learning step is executed before starting marking the label side of the optical disc. After an optical disc to be marked at the label side is loaded, the optical disc is rotated. In the learning step, the optical head emits a laser beam of a lower power onto the label side of the optical disc to realize the reflection levels of the optical disc. Accordingly, a strategy for controlling the lens of the optical head can be determined. The control strategy is then recorded into a memory of the optical disc recording apparatus. By way of the learning step, the correlation of the wobble levels to the rotating angles (or spokes) of the optical disc can be realized. In addition, offset voltages can be realized to be superposed on the focus servo control signal.

Please refer to FIG. 3, which is a wobbling level vs. spoke plot realized in a general learning step. According to the plot of FIG. 3 resulting from the learning step, the distance from the lens of the optical head to the surface of the optical disc for each spoke can be realized. For example, the wobble levels are zero at the spokes Sa, Sb, Sc, Sd and Se. It means that when the optical head is located at positions corresponding to the spokes Sa, Sb, Sc, Sd and Se, the laser beam passing through the lens of the optical head can be well focused on the surface of the optical disc. On the other hand, when the optical head is located at a position lying between the spokes Sa and Sb, the lens of the optical head is closer to the surface of the optical head than the well focused positions, and when the optical head is located at a position lying between the spokes Sb and Sc, the lens of the optical head is further to the surface of the optical head than the well focused positions. Accordingly, the optical disc recording apparatus has to provide an offset voltage in the subsequent label-marking step to adjust the distance from the lens of the optical head to the optical disc so as to keep the distance constant. In other words, the lens of the optical head will wobble with the optical disc in order to improve the marking effect of the label side.

Referring back to FIG. 2(b), after the learning step is completed, the focusing servo control signal generated by the DSP 11 will exhibit offset voltage. The DAC 12 then converts the digital focusing servo control signal into an analog output signal. The analog output signal is amplified by the driving circuit 13, and then used to control the actuator 14 to move the lens of optical head.

FIG. 4 shows the analog output signal generated by the DAC 12. The DAC 12 utilizes a plurality of voltage levels to approach the actual analog signal. Since the focusing servo control signal includes an offset voltage component for variably adjusting the distance between the lens and the disc, the resulting analog output signal switches among the voltage levels accordingly. In order to facilitate the switching of the analog output signal from one voltage level to another, high-frequency oscillation is involved to start the level switching. Accordingly, the actuator 14 of the optical head exhibits regular mechanical oscillation in response to the analog output signal amplified by the driving circuit 13. The regular mechanical oscillation of the actuator 14 makes the lens oscillate, and thus the pattern marked on the label side of the optical disc may exhibit color or grey-level gaps along the circumferential direction.

### SUMMARY OF THE INVENTION

Therefore, the present invention provides an optical disc recording apparatus capable of marking a label side of an optical disc, which aims for alleviating the oscillation effect so as to improve the image quality of the marked pattern.

An optical disc recording apparatus having an optical head to write a label side of an optical disc according to an embodiment of the present invention includes a digital signal processor for outputting a focusing servo control signal; a digital-to-analog converter coupled to the digital signal processor for converting the focusing servo control signal into an analog output signal; a low pass filter coupled to the digital-to-analog converter for receiving and filtering the analog output signal to remove a high-frequency portion of the analog output signal; a driving circuit coupled to the low pass filter for receiving and amplifying the filtered analog output signal; and an actuator coupled to the driving circuit for controlling the movement in response to the amplified analog output signal.

In an embodiment, the low pass filter is an analog low pass filter.

In an embodiment, the focusing servo control signal includes an offset voltage component after a learning step of the optical disc recording apparatus. The analog output signal is generated in response to the focusing servo control signal with the offset voltage component and has stepped voltage levels.

An optical disc recording apparatus having an optical head to write a label side of an optical disc according to an embodiment of the present invention includes a digital signal processor for outputting a focusing servo control signal; a digital low pass filter coupled to the digital signal processor for receiving and filtering focusing servo control signal to remove a high-frequency portion of the focusing servo control signal; a digital-to-analog converter coupled to the digital low pass filter for converting the filtered focusing servo control signal into an analog output signal; a driving circuit coupled to the low pass filter for receiving and amplifying the analog output signal; and an actuator coupled to the driving circuit for controlling the movement in response to the amplified analog output signal.

### BRIEF DESCRIPTION OF THE DRAWINGS

The above contents of the present invention will become more readily apparent to those ordinarily skilled in the art after reviewing the following detailed description and accompanying drawings, in which:

FIG. 1(a) is a diagram schematically illustrating a typical optical disc with a markable label side;

FIG. 1(b) is a diagram schematically illustrating a center portion of an optical disc with a markable label side;

FIG. 2(a) is a diagram schematically illustrating partial devices of an optical disc recording apparatus for marking the label side of an optical disc;

FIG. 2(b) is a functional block diagram of a conventional optical disc recording apparatus for controlling the recording of an optical disc;

FIG. 3 is a wobbling level vs. spoke plot realized in the learning step of an optical disc recording apparatus;

FIG. 4 is an analog output signal vs. spoke plot realized in the writing step of a conventional optical disc recording apparatus;

FIG. 5(a) is a functional block diagram of an optical disc recording apparatus for controlling the recording of an optical disc according to an embodiment of the preset invention;

FIG. 5(b) is a functional block diagram of an optical disc recording apparatus for controlling the recording of an optical disc according to another embodiment of the preset invention; and

FIG. 6 is an analog output signal vs. spoke plot realized in the writing step of an optical disc recording apparatus according to the present invention.

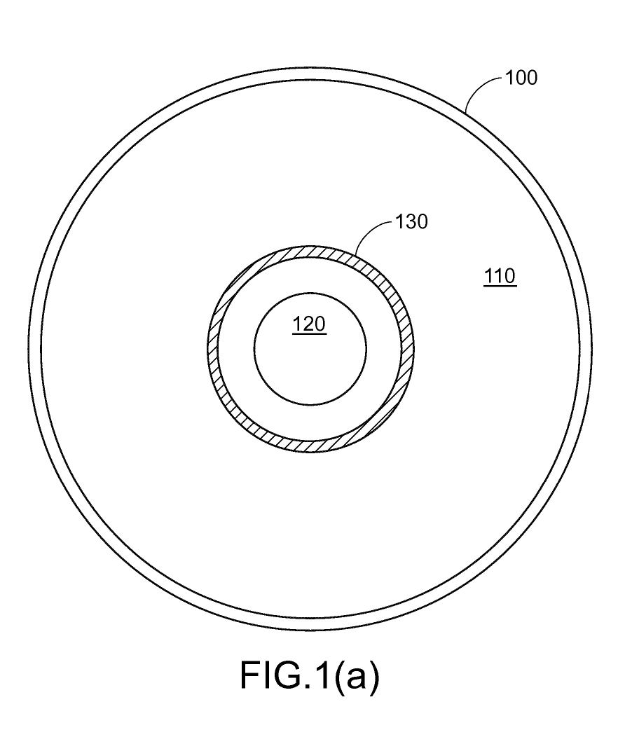

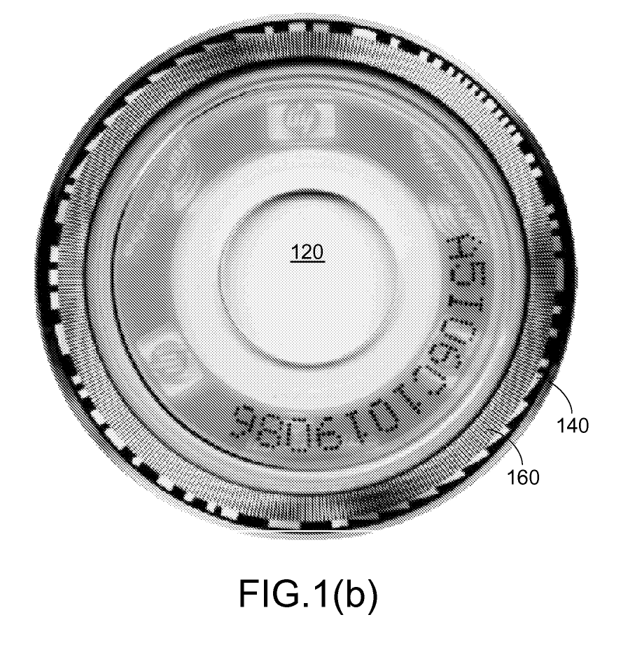

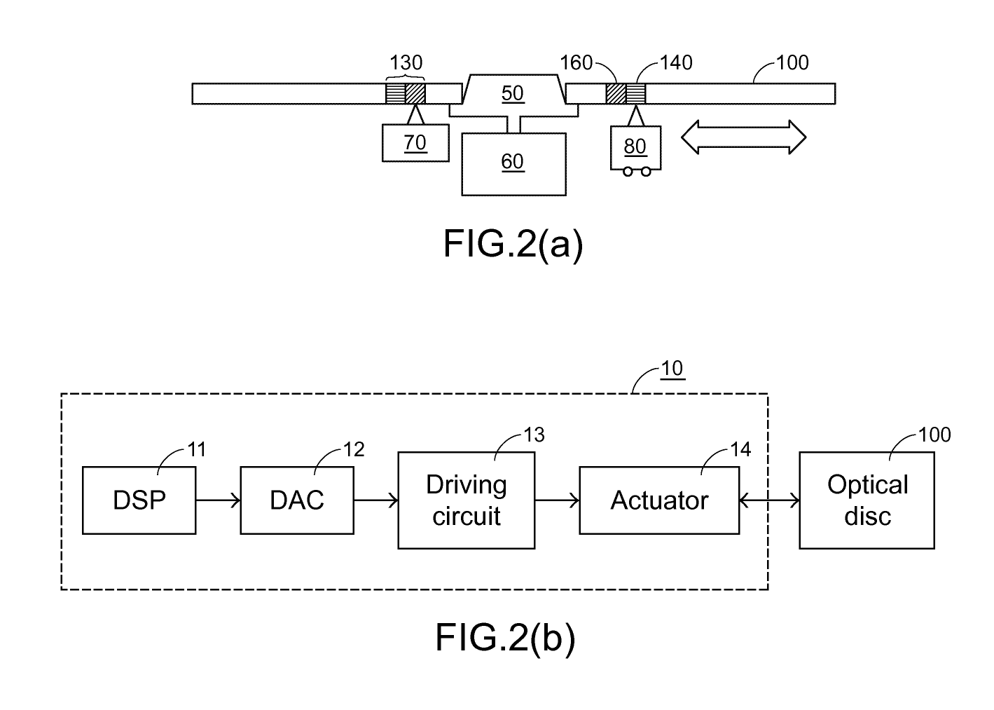

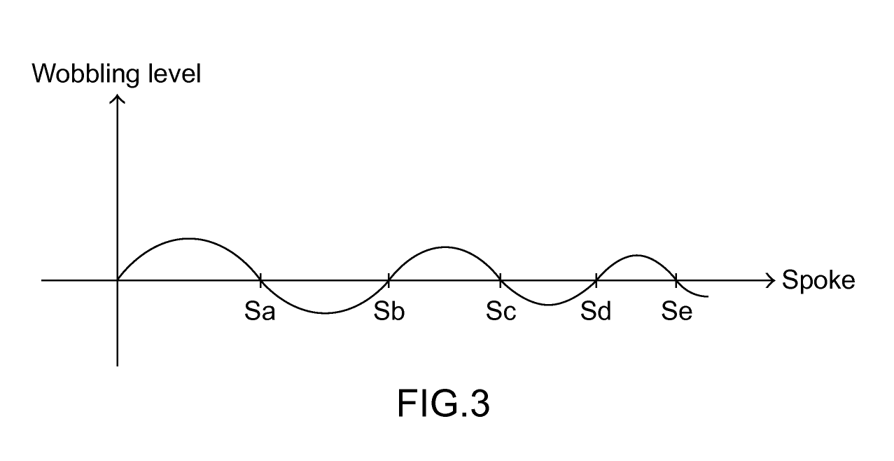

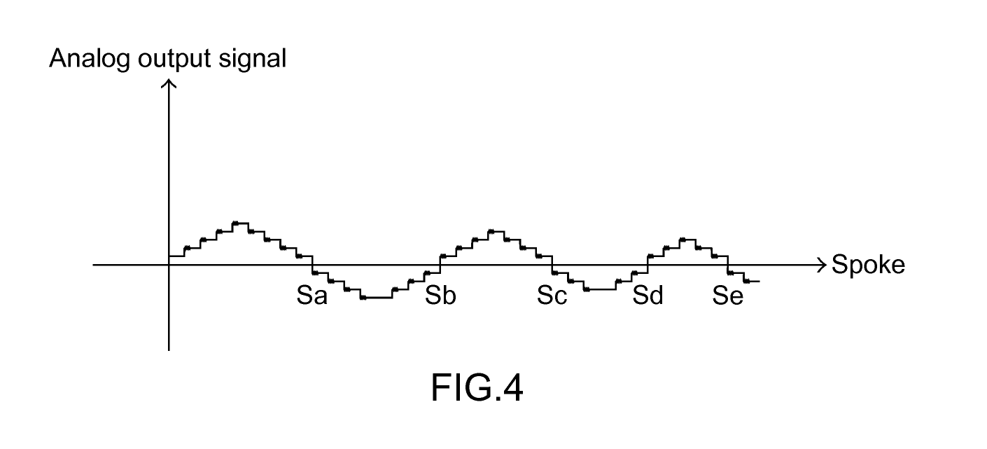

### DETAILED DESCRIPTION OF THE PREFERRED EMBODIMENT

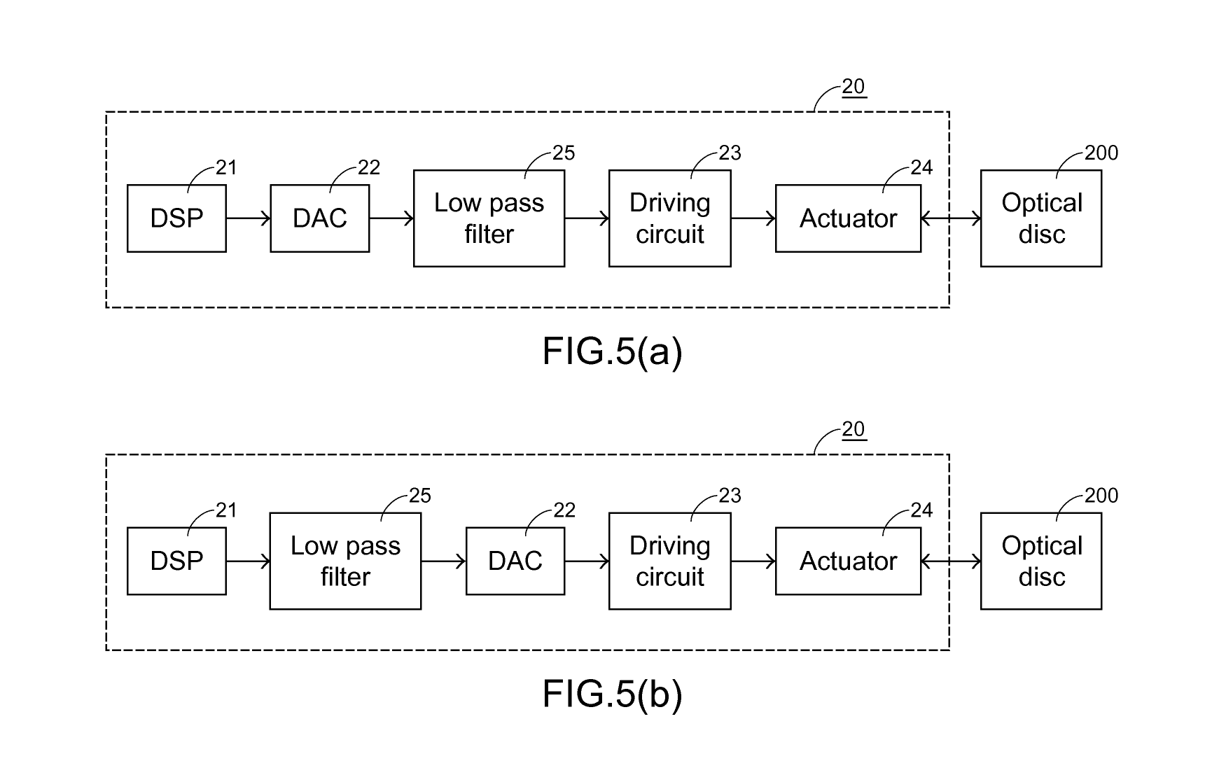

For improving the image quality of the pattern marked on the label side, a low pass filter is used to alleviate the oscillation effect. An embodiment of optical disc recording apparatus incorporating therein such a low pass filter is illustrated in FIG. 5(a). The optical disc recording apparatus 20 including a DSP (digital signal processor) 21, a DAC (digital-to-analog converter) 22, a low pass filter 25, a driving circuit 23 and an actuator 24 coupled to each other in series.

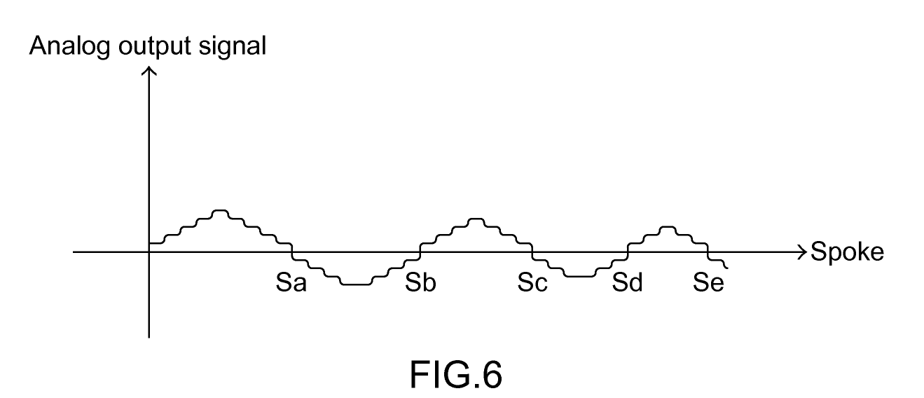

As usual, the optical disc recording apparatus performs a learning step before the real writing step after an optical disc to be marked is loaded therein, thereby realizing the wobbling levels of the optical disc corresponding to various spokes. After the learning step, the optical disc recording apparatus starts to mark on the label side of the optical disc. The DSP 21 outputs a digital focusing servo control signal that includes an offset voltage component. The digital focusing servo control signal is processed by the DAC 22 to generate an analog output signal with stepped voltage levels. For each voltage level step, high-frequency oscillation occurs. When the analog output signal passes through the low pass filter 25, the low pass filter 25 filters out the high-frequency portion in the analog output signal. The resulting analog output signal, as illustrated in FIG. 6, shows smoothened level switching. Therefore, after the low-pass-filtered analog output signal is amplified by the driving circuit 23 and inputted to the actuator 24, the oscillation of the lens due to the high-frequency oscillation of the analog output signal can be alleviated or diminished. Thus the color or grey-level gaps conventionally existing in the marked pattern can be removed.

In the above embodiment, the low pass filter 25 is used to filter out the high-frequency portion in the analog output signal. Alternatively, the low pass filter 25 can be used between the DSP 21 and DAC 22 for processing the digital focusing servo control signal instead, as shown in FIG. 5(b). The low pass filter 25 may function to enhance the resolution of the digital focusing servo control signal. For example, a plurality of sub-levels are inserted in between two voltage levels of the digital focusing servo control signal. When the DAC 22 converts the digital focusing servo control signal into the analog output signal, the analog output signal will become smoother. In this way, the high-frequency portion can be reduced or removed so as to have the oscillation effect of the actuator 24 alleviated or diminished. Therefore, the color or grey-level gaps can be removed while keeping the lens well tracing the wobbling disc.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An optical disc recording apparatus having an optical head to write a label side of an optical disc, comprising:
a digital signal processor for outputting a focusing servo control signal;
a digital-to-analog converter coupled to the digital signal processor for converting the focusing servo control signal into an analog output signal;
a low pass filter coupled to the digital-to-analog converter for receiving and filtering the analog output signal to remove a high-frequency portion of the analog output signal;
a driving circuit coupled to the low pass filter for receiving and amplifying the filtered analog output signal; and
an actuator coupled to the driving circuit for controlling the movement in response to the amplified analog output signal.

2. The optical disc recording apparatus according to claim 1 wherein the low pass filter is an analog low pass filter.

3. The optical disc recording apparatus according to claim 1 wherein the focusing servo control signal includes an offset voltage component after a learning step of the optical disc recording apparatus.

4. The optical disc recording apparatus according to claim 3 wherein the analog output signal is generated in response to the focusing servo control signal with the offset voltage component and has stepped voltage levels.

5. An optical disc recording apparatus having an optical head to write a label side of an optical disc, comprising:
a digital signal processor for outputting a focusing servo control signal;
a digital low pass filter coupled to the digital signal processor for receiving and filtering focusing servo control signal to remove a high-frequency portion of the focusing servo control signal;
a digital-to-analog converter coupled to the digital low pass filter for converting the filtered focusing servo control signal into an analog output signal;
a driving circuit coupled to the low pass filter for receiving and amplifying the analog output signal; and
an actuator coupled to the driving circuit for controlling the movement in response to the amplified analog output signal.

6. The optical disc recording apparatus according to claim 5 wherein the focusing servo control signal includes an offset voltage component after a learning step of the optical disc recording apparatus.

7. The optical disc recording apparatus according to claim 6 wherein the analog output signal is generated in response to the focusing servo control signal with the offset voltage component and has stepped voltage levels.
